(19) United States
(12) Patent Application Publication
(10) Pub. No.: US 2020/0198789 A1
(43) Pub. Date: Jun. 25, 2020

(54) Aircraft-Based Atmospheric Water Generation System and Methods

(71) Applicant: Cory Jacob Hammock, Salt Lake City, UT (US)

(72) Inventor: Cory Jacob Hammock, Salt Lake City, UT (US)

(21) Appl. No.: 16/365,184

(22) Filed: Mar. 26, 2019

Related U.S. Application Data
(63) Continuation-in-part of application No. 16/152,786, filed on Oct. 5, 2018.

(51) Int. Cl. B64D 13/06; B64D 1/00; B64D 11/00; B64D 11/02; B64D 11/04

(52) U.S. Cl. CPC B64D 13/06; B64D 1/00; B64D 11/0007; B64D 2013/0674; B64D 11/04; B64D 2013/0662; B64D 11/02

(57) ABSTRACT

The invention is a system and method of use for the aircraft-based generation of usable water from atmospheric water vapor for storage and use within the aircraft.

### CROSS REFERENCE TO RELATED APPLICATIONS

This application is a continuation-in-part of U.S. patent application Ser. No. 16/152,786, ed on Oct. 5, 2018.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a system and method for the generation of usable water in or on an aircraft from atmospheric water vapor.

### Background of the Invention

Dehumidifying technology was pioneered in an effort to keep indoor humidity levels low, primarily for comfort and reduction in housing/commercial structures. Within geographic areas of high humidity, the technology will convert humidity into water through condensation. With the inclusion of filtering devices to remove potential contaminants, the same technology has become known as atmospheric water generation (AWG).

Atmospheric water generation uses dehumidifying technology with added filters to generate usable and/or potable water. The invention as described and claimed herein is intended for the purposes utilizing atmospheric, preferably high altitude, water vapor to provide usable water to an aircraft during flight.

The rate at which water can be produced depends on relative humidity and ambient air temperature and size of the compressor. Atmospheric water generators become more effective as relative humidity and air temperature increase. As a rule of thumb, cooling condensation atmospheric water generators do not work efficiently when the temperature falls below 18.3° C. (65° F.) or the relative humidity drops below 30%. Thus, an AWG system is likely to function at a more efficient rate in warmer climates or during warmer growing seasons, especially during daylight hours. That said, an aircraft flying at altitude will gain access to clouds and other upper atmospheric vapor, which are capable of providing large quantities of liquid water.

With the addition of activated carbon filtering, AWG devices can provide a source of natural and safe water for drinking or washing. Generally, dehumidifiers output water via a condensation drip into a water receptacle, thus collecting metallic and chemical elements to render the collected water potentially unsafe for drinking or agricultural use. As such, additional filtration mechanisms are recommended to prepare harvested water for safe human use.

Known AWG systems fail to combine features of atmospheric water harvesting with modern air transportation. Applicant's claimed system and methods achieve these objectives for the generation, and dispersal usable water from atmospheric water vapor for in-flight use and, potentially, for supplementation of airport water supplies.

### BRIEF SUMMARY OF THE INVENTION

In a preferred embodiment, An aircraft-based atmospheric water generation system, comprising air fans to pull atmospheric air into the aircraft, wherein a compressor-type dehumidifier condenses water from atmospheric vapor and drains the condensed water into one or more collection tanks, one or more water pumps located in the collection tank each pump the condensed water into an outflow pipe for delivery to one or more water use points within the aircraft.

In another preferred embodiment, the aircraft-based atmospheric water generation system as described herein, wherein a power line from an aircraft generator connects to an amplifier, then extends to one or more capacitors, which capacitor(s) are each connected by inner power lines, directly or indirectly, to one or more air fans, dehumidifier components and water pumps.

In another preferred embodiment, the aircraft-based atmospheric water generation system as described herein, further comprising wherein the dehumidifier is located within the stabilizers of the aircraft tail assembly and the water pump(s) and collection tank(s) are located within the body of the aircraft.

In another preferred embodiment, the aircraft-based atmospheric water generation system as described herein, wherein one or more water filters are located in the water pump or outflow pipe.

In another preferred embodiment, the aircraft-based atmospheric water generation system as described herein, wherein the outflow pipe lessens in diameter as it extends away from the collection tank.

In another preferred embodiment, the aircraft-based atmospheric water generation system as described herein, further comprising a dessicant-type dehumidification system, either in addition to or in lieu of a compression-type dehumidification system.

In another preferred embodiment, the aircraft-based atmospheric water generation system as described herein, wherein a collection pan is arranged beneath condensation coils of the dehumidifier within each stabilizer, such collection pan angled towards a water pump within the aircraft body.

In another preferred embodiment, the aircraft-based atmospheric water generation system as described herein, wherein the collection pan in the vertical stabilizer is funnel-shaped.

In another preferred embodiment, the aircraft-based atmospheric water generation system as described herein, a plurality of powered air fans are arranged in the upper side of each horizontal stabilizer and on one or both sides of the vertical stabilizer.

In another preferred embodiment, the aircraft-based atmospheric water generation system as described herein, wherein the collection pan narrows upon reaching the water pump to provide water directly to such water pump.

In another preferred embodiment, the aircraft-based atmospheric water generation system as described herein, further comprising an emergency powered water pump leading to a drainage line and an emergency drainage valve on the outside of the aircraft.

In another preferred embodiment, the aircraft-based atmospheric water generation system as described herein, wherein no coolant is required to effect water condensation from atmospheric air.

In another preferred embodiment, a method of providing pressurized water for use onboard an aircraft comprising the steps of:
i. dehumidifying atmospheric air using the aircraft-based atmospheric water generation system of claim 1,
ii. using a first powered water pump to pump condensed water into a collection tank,
iii. using a second powered water pump to pump condensed water into an outflow pipe,
iv. filtering unwanted substances from the condensed water, and
v. attaching one or more faucets, toilets or sprinklers to the outflow pipe.

In another preferred embodiment, the method of providing pressurized water for use onboard an aircraft as described herein, further comprising the step: vi. pumping excess water offboard the aircraft upon landing for use at an airport.

### BRIEF DESCRIPTION OF THE DRAWINGS

FIG. 1 is a line drawing evidencing an atmospheric water generation system with the system's dehumidification components arranged within the tail assembly of an aircraft.

FIG. 2 is a line drawing evidencing an aircraft-based atmospheric water generation system, wherein generated water is distributed to points of use throughout the aircraft.

FIG. 3 is a line drawing evidencing a close-up view of a single air fan and accompanying electrical and dehumidifier components.

### DETAILED DESCRIPTION OF THE INVENTION

The invention as described and claimed herein is an atmospheric water generation (AWG) system intended for the purposes of reclaiming atmospheric water for storage and use aboard an aircraft. The disclosed system is best employed by larger aircraft capable of long distance travel, since the dehumidification components will require sufficient space for mounting and sufficient time for water generation. Thus, the system will be especially useful in commercial or military passenger or cargo aircraft, while the use of somewhat miniaturized components may also be used in smaller corporate jets capable of travelling long distances at high altitude.

Typical cruising altitudes of commercially available airliners or large cargo planes today is 30,000 to 42,000 feet, with a preferred height in the “sweet spot” between 35,000 and 42,000 feet, which altitude still provides sufficient oxygen to fuel the engines while providing reduced air resistance. Smaller corporate jets may fly at heights up to 51,000 feet. Average air temperatures at high altitudes become quite low. For example, the average temperature at 35,000 feet is −65 degrees F. and at 50,000 feet approaches −70 degrees F. At such very low air temperature levels, limited or no coolant may be required for dehumidifying condensation coils to convert atmospheric gaseous water vapor into liquid condensation.

AWG technology can intake atmospheric water vapor through evaporator coil heating, using electrical air fans on the outer shell of the aircraft to pull in vapor for condensation, storage and reuse. Once condensed, gravity pulls the resulting liquid water downward from the coils effecting condensation and into a collection tank, which can either be a separate component or a defined area beneath the coils. In one embodiment, the area at the bottom of the case containing the dehumidification components will serve as the collection tank. In another embodiment, the falling condensation is directed by a pan or funnel(s) into a separate collection tank or pipe leading to such a tank.

At the bottom of the collection tank area, one or more powered water pumps will be arranged, each connected to a generator by a power line, with each such pump comprising an intake hole for pulling in condensed water and an output hole for pumping out such water. Such water pumps will be powered by the onboard aircraft power supply.

In one embodiment, a carbon filter will be placed to filter out impurities before pumping will be placed either at the entrance to or exit from the pump, or within a connected outflow pipe. The output hole will connect to the outflow pipe, which pipe will connect to the aircraft's water system for use in the galleys and bathrooms. In an alternate embodiment, the outflow pipe may also feed one or more fire control sprinklers. Such pipe will preferably comprise one or more valves that can be adjusted to regulate flow, either manually or electronically. As the outflow pipe approaches one or more end use points, a pressure regulator will be arranged along the pipe.

The system invention utilizes known methods of powered dehumidification, with novelty in the arrangement within the limited confines and specific layout of a personal or commercial aircraft. In practice, moist atmospheric air is drawn into a compressor-style dehumidifier mechanism by one or more powered air fans. Given the lower temperature of atmospheric air at high altitude, the use of a powered heater at the entry point for each air fan is optional. The air taken into the system passes into a crossflow plate heat exchanger where a substantial proportion of the sensible heat is transferred to a cool supply air stream. This process brings the extracted air close to saturation. The air then passes across the refrigerant-cooled evaporator coil of the heat pump where the air is cooled and the moisture is condensed.

As higher elevation consists of substantially cooler temperate conditions, minimal or even no coolant will be required for the evaporator coils to convert gaseous water vapor into a liquid at certain altitudes. Smaller passenger commercial aircraft that traverse lower altitudes, or aircraft flying within tropical regions may still require liquid coolant for condensation, albeit at much lower amounts that would be required at ground level. For commercial, military and long-distance personal jets, all of which fly at higher altitudes, coolant should not be required for normalized operations however, continuous refrigerant forced entry throughout the evaporator coils will be critical to prevent the coils from freezing at extreme lower temperatures.

The dehumidification process yields substantial amounts of latent energy to the refrigeration circuit. Refrigeration within AWG system circuit(s) power consumption can be determined by variable enthalpy of condensation calculations to account for atmospheric properties of water vapor pressure and latent heat required to transform vapor into condensed liquid water thus, invoking exothermic conversion properties. The enthalpy of condensation (exothermic) is the direct opposite output of the enthalpy of vaporization (endothermic). Enthalpy of vaporization may be calculated by:

q=(ΔHᵥₐₚ)/(mass/molar mass)

wherein

q=total heat (H) involved

ΔHᵥₐₚ=molar heat (H) of vaporization (expressed in joules)

Mass=mass of substance represented in moles (mol)

Water (H₂O) yields a 40.7 kJ/mol enthalpy of vaporization with 1 mol of water being 18.015 g/mol; 18.015 g/mol of water exists as a gas at 100 degrees Celsius. Conversely, −40.7 kJ/mol represents the enthalpy of condensation to transform water vapor to liquid water. Using the Clausius-Clapeyron equation, heat utilization of phase transitions from vapor pressures can be measured over two temperatures. The Clausius-Clapeyron equation is represented as:

1n(P₁/P₂)=ΔHᵥₐₚ/R((1/T₂)−(1/T₁))

wherein

ln=natural log

P=two vapor pressures at two temperatures (expressed in standard atmosphere, atm)

T=temperatures (expressed in Kelvin)

ΔHᵥₐₚ=molar heat (H) of vaporization (expressed in joules)

R=gas constant (8.3145 J mol⁻¹ K⁻¹)

Saturated vapor pressure is relative directly to temperature; using the Antoine mathematical expression, vapor pressure of water can be determined by the log of H₂O specific coefficients. The AWG integral aircraft system used between the altitudes of 35,000 and 50,000 feet represents the following average conditions:
35,000 ft.=−65 degrees F. (219.261 degrees K) [T₂] and 0.00002385 atm [P₂]
50,000 ft.=−70 degrees F. (216.483 degrees K) [T₁] and 0.000016643 atm [P₁]

Using the Clausius-Clapeyron equation for the above two atmospheric variables, a yield of 51.114 kJ/mol is determined for molar heat vaporization for the AWG process at average commercial aircraft altitudes. 51.114 kJ/mol enthalpy of vaporization=−51.114 kJ/mol enthalpy of condensation. Thus, −51.114 kJ/mol is the amount of exothermic heat flow required from the preferred embodiment to condense water vapor at average commercial aircraft cruising altitudes into liquid water.

Fresh air is then introduced to replace the amount that was extracted and the mix is discharged by the supply fan to the crossflow heat exchanger where it is heated by the extracted air. This pre-warmed air then passes through the heat pump condenser where it is heated by the latent energy removed during the condensation process and/or the energy input to the compressor. The warm dry air is then discharged into the atmosphere. In a given embodiment, the system may further comprise a sensor-activated heater/blower (s) adjacent to the evaporator coils that engages upon sensing ice buildup on the coils.

In an alternate embodiment, the dehumidifier mechanism comprises a desiccant-style dehumidifier, or a combination of compressor-style and desiccant-style dehumidifiers.

In a preferred embodiment, the dehumidifier mechanism is arranged inside the body of a subject aircraft, preferably at the rear of the aircraft behind any passenger cabin or cargo stowage area. In such an arrangement, a plurality of air fans are located inside the skin of the aircraft, either directly open to the air or located behind a cover plate which can be opened and closed using a powered motor, such as by sliding. In another embodiment, the cover may be a series of slats that are opened and closed by rotation, in a fashion similar to the opening of venetian blinds.

In one embodiment, the components of the dehumidifier are contained within the horizontal stabilizers and/or vertical stabilizer of the aircraft tail assembly. Such components would necessarily need to leave sufficient room for the control flaps and associated wiring and motors, but the limited depth of such stabilizers would create an ideal location for the condensation, gathering and pumping of water. In this embodiment, several air fans could be located across the top length of a given horizontal stabilizer, with condenser coils, evaporator coils and associated components immediately beneath the fans. In the vertical stabilizer, if used, the air fans would be arranged along one or both sides. As condensation is created by the dehumidifer coils, it would drip onto a collection pan beneath such coils, with such pan being angled to create natural water flow towards the body of the aircraft. Each such collection pan narrows as it reaches the aircraft body, at which point it the condensation pours into a powered water pump for pumping the water via a hose or line into one or more collection tanks. In a preferred embodiment, such tank would be located at a lower level of the aircraft body than that of the water pump to lessen the power required for pumping.

As the fuel tanks in most civil aircraft and military cargo aircraft tend to run through the center of the plane and in the wings, sufficient space is likely to be available for the disclosed AWG system's dehumidifier components in the stabilizers. While certain military and civilian aircraft, notably the Airbus A380, may contain fuel tanks in and around the horizontal stabilizers, these designs still leave the vertical stabilizer free for AWG activities.

In one embodiment, the water collection tank is fitted with an emergency powered water pump leading to a drainage line and emergency drainage valve on the outside of the aircraft, which mechanism would allow pilots to jettison water on an emergency basis to lower tail assembly weight or overall aircraft weight. In another embodiment, the entire AWG system is subject to automatic and/or manual shutoff once a level measurement device in the collection tank indicates that the tank is full.

In circumstances in which the water generation capacity of the aircraft-based system outproduces the need for water onboard, a percentage of the excess water remaining at the end of each flight might be pumped into a container vehicle for use at an airport.

### DETAILED DESCRIPTION OF THE FIGURES

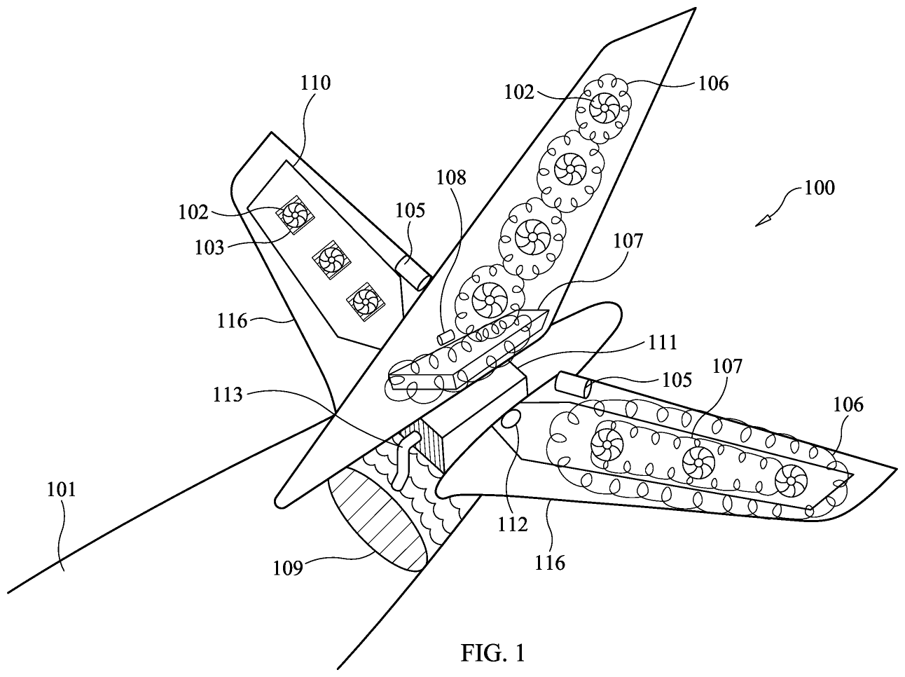

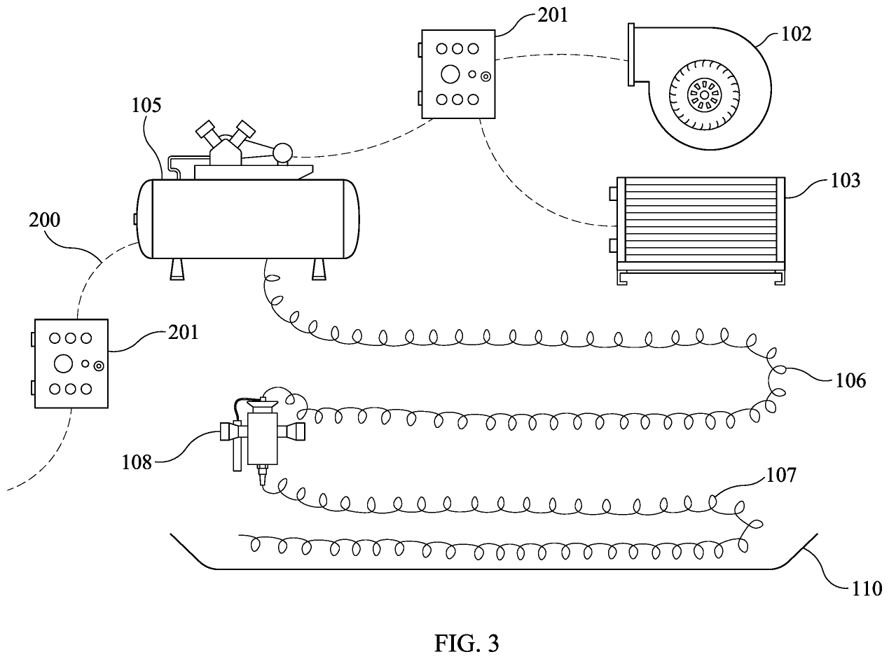

FIG. 1 shows a cross-section of an atmospheric water generating system 100, wherein all dehumidification components and water collection is contained within the tail assembly of an aircraft 101. Within the aircraft 101, a plurality of air fans 102 are located within the skin of the aircraft, with each fan intaking surrounding atmospheric air or blowing processed air out. As the air is intaken by an intake air fan, such air passes across or through a crossflow heat exchanger 103, optionally to include an expansion valve (not pictured), to harvest the water vapor within. For clarity of illustration, the fans and crossflow heat exchangers only are pictured in the right horizontal stabilizer 116, which only air fans and condenser coils 106 and evaporator coils 107 are pictured in the left horizontal stabilizer. The fans and all other electronic components within the air craft skin are powered via one or more power lines 200 (not pictured), each running directly or indirectly to an aircraft-based generator or similar power source used for powering all electrical components of the aircraft (not pictured). For a full illustration of the interrelation of all such dehumidifier and electrical components, please see FIG. 3 and its description.

FIG. 1 further indicates a classic compression-type dehumidifier model, wherein the air crosses the crossflow heat exchanger then through a set of heated condenser coils 106. The warmed air then passes over separate cooled evaporator coils 107, to lower the air temperature and effect condensation of the airborne water vapor into liquid water, which gathers on the evaporator coils and drips downward into collection pan 110. The processed air is then pulled across the heated condenser coils 106 before being ejected as exhaust by exhaust air fans 102. Functioning together, the air fans, compressors 105, condenser coils, evaporator coils and expansion valves 108 connecting the condenser and evaporator coils (not pictured) comprise a dehumidifier.

The collection pans 110 in each horizontal stabilizer 116 are shown underlying the condenser coils 106 to catch liquid condensation. The collection pan allows the liquid to flow towards the aircraft body and the intake hole 112 of water pump 111, which then pumps the liquid into collection tank 109 via first outflow pipe 113. In a preferred embodiment, the collection tank is employed as a single, integral component, either lined or unlined to minimize the prospect of leaking. Preferred materials for the optional liner include, without limitation, fiberglass, ceramics, vinyl such as PVC or similar polymers, or lightweight, corrosion resistant metal sheeting.

The collection pan 110 beneath the condenser coils 106 of the vertical stabilizer is pictured as funnel-shaped and directing the liquid condensation towards an intake hole 112 in the top of the water pump 111.

In an alternate embodiment, the compression-style dehumidifier of FIG. 1 may be replaced or supplemented with an alternative technology using liquid, or “wet” desiccants such as lithium chloride or lithium bromide to pull water from the air via hygroscopic processes. A similar technique is also practicable combining the use of solid desiccants, such as silica gel and zeolite, with pressure condensation.

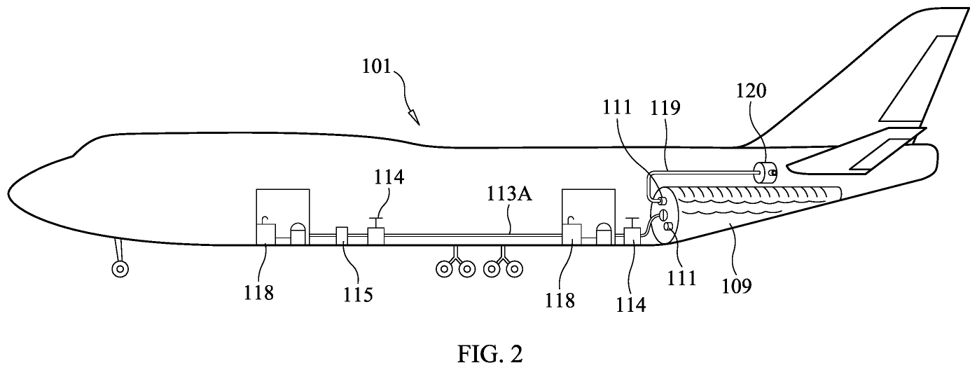

FIG. 2 illustrates an aircraft 101, comprising a water collection tank 109 towards the lower rear of the aircraft in front of horizontal stabilizer 116. One water pump 111 located in the collection tank pumps water along second outflow pipe 113A to one or more water use points 118, pictured as lavatories in the drawing. A second water pump 111, also located in the collection tank 109, is capable of pumping water to drainage line 119 on an emergency basis to drainage valve 120, which pump and valve can be manually or automatically activated as needed to jettison collected water out of the aircraft to lower the weight either of the tail assembly in relation to the rest of the aircraft, or the weight of the aircraft itself.

In one embodiment, a carbon filter (not pictured) will be placed over the intake hole 112 of the water pump (not pictured) to filter out impurities before pumping towards water use points. Further, the second outflow pipe 113A will likely comprise one or more outflow pipe valves 114 that can be adjusted to regulate flow, either manually or electronically. In another embodiment, such filter may be placed inside the second outflow pipe 113A at an outflow pipe valve 114, thereby allowing the outflow to be temporarily cut off by the valve for cleaning and/or replacement of such filter. As the outflow pipe approaches a water use point, a pressure regulator 115 may also be arranged along the outflow pipe.

The pressure regulator can be configured via a multitude of ways however, this can be configured both manually via mechanical triggers or automatically via software rules and remote sensing applications. Configuration agnostic, a pressure regulator is first triggered when water enters a throttling stem from the input valve. The throttling stem is held open via a spring system housed around the hollow tube and diaphragms attempt to seal the output valve; pressure is then regulated by the compression strength of the springs surrounding the throttling stem as water traverses the regulator. These characteristics are well known and thus not pictured. For optimum results, the regulator should be located between the pipe valves 114 and the water use point 118, as shown in FIG. 2.

FIG. 3 shows an up-close version of the dehumidifier mechanism surrounding a single intake air fan 102, wherein a power line 200 connects a capacitor/transformer 201 to a generator or other aircraft power source (not pictured), and thence connects a compressor and capacitator/transformer, which stores power and transfers it to the air fan 102 for air intake, along with the cross flow heat exchanger.

FIG. 3 illustrates a classic compression-type dehumidifier model, wherein a compressor 105 compresses a refrigerant (for example, without limitation, commercially known chlorofluorocarbons, hydrochlorofluorocarbons, or hydrofluorocarbons) in gas form and pumps it through a set of condenser coils 106, where the gas heats and becomes a liquid, with the condenser coils dissipating the heat. The refrigerant liquid then passes through an expansion valve(s) 108 and into separate evaporator coils 107, where the refrigerant expands into a gas, thereby dropping in temperature and cooling the evaporator coils before returning to the compressor. The expansion valves provide dynamic resistance and flow control over the amount of refrigerant released into the evaporator.

Air is taken in by an air fan(s) 102, which then pushes the air over the warm condenser coils and then the cold evaporator coils 107 to lower the air temperature and cause condensation of the airborne water vapor into liquid water, which gathers on the evaporator coils and drips downward into collection pan 110, while the air is pulled across the heated condenser coils 106 before being ejected as exhaust by one or more additional outflow air fans 120. Functioning together, the air fans, compressor, condenser coils, evaporator coils and expansion valves comprise a dehumidifier, with condensation collected in the collection pan 110 being moved towards and into a water pump 111 as also pictured in FIG. 1.

### INDEX OF PARTS

100 AWG System
101 Aircraft
102 Air fan
103 Crossflow heat exchanger
104 Amplifier
105 Compressor
106 Condenser coils
107 Evaporator coils
108 Expansion valves
109 Collection tank
110 Collection pan
111 Water pump
112 Intake hole
113 First outflow pipe
113A Second outflow pipe
114 Valve
115 Pressure regulator
116 Horizontal stabilizer
117 Vertical stabilizer
118 Water use point
119 Drainage line
120 Drainage valve
200 Power lines
201 Control box
202 Capacitor/transformer
203 Interior power lines

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. An aircraft-based atmospheric water generation system, comprising air fans to pull atmospheric air into the aircraft, wherein a compressor-type dehumidifier condenses water from atmospheric vapor and drains the condensed water into one or more collection tanks, one or more water pumps located in the collection tank each pump the condensed water into an outflow pipe for delivery to one or more water use points within the aircraft.

2. The aircraft-based atmospheric water generation system of claim 1, wherein a power line from an aircraft generator connects to an amplifier, then extends to one or more capacitors, which capacitor(s) are each connected by inner power lines, directly or indirectly, to one or more air fans, dehumidifier components and water pumps.

3. The aircraft-based atmospheric water generation system of claim 1, further comprising wherein the dehumidifier is located within the stabilizers of the aircraft tail assembly and the water pump(s) and collection tank(s) are located within the body of the aircraft.

4. The aircraft-based atmospheric water generation system of claim 1, wherein one or more water filters are located in the water pump or outflow pipe.

5. The aircraft-based atmospheric water generation system of claim 1, wherein the outflow pipe lessens in diameter as it extends away from the collection tank.

6. The aircraft-based atmospheric water generation system of claim 1, further comprising a dessicant-type dehumidification system, either in addition to or in lieu of a compression-type dehumidification system.

7. The aircraft-based atmospheric water generation system of claim 3, wherein a collection pan is arranged beneath condensation coils of the dehumidifier within each stabilizer, such collection pan angled towards a water pump within the aircraft body.

8. The aircraft-based atmospheric water generation system of claim 3, wherein the collection pan in the vertical stabilizer is funnel-shaped.

9. The aircraft-based atmospheric water generation system of claim 3, wherein a plurality of powered air fans are arranged in the upper side of each horizontal stabilizer and on one or both sides of the vertical stabilizer.

10. The aircraft-based atmospheric water generation system of claim 7, wherein the collection pan narrows upon reaching the water pump to provide water directly to such water pump.

11. The aircraft-based atmospheric water generation system of claim 1, further comprising an emergency powered water pump leading to a drainage line and an emergency drainage valve on the outside of the aircraft.

12. The aircraft-based atmospheric water generation system of claim 1, wherein no coolant is required to effect water condensation from high-altitude atmospheric air.

13. A method of providing pressurized water for use onboard an aircraft comprising the steps of:
i. dehumidifying atmospheric air using the aircraft-based atmospheric water generation system of claim 1,
ii. using a first powered water pump to pump condensed water into a collection tank,0
iii. using a second powered water pump to pump condensed water into an outflow pipe,
iv. filtering unwanted substances from the condensed water, and
v. attaching one or more faucets, toilets or sprinklers to the outflow pipe.

14. The method of providing pressurized water for use onboard an aircraft of claim 13, further comprising the step:
vi. pumping excess water offboard the aircraft upon landing for use at an airport.
